(19) United States
(12) Patent Application Publication
(10) Pub. No.: US 2001/0016146 A1
(43) Pub. Date: Aug. 23, 2001

(54) Assembly formed from a cylinder and a hollow member

(76) Inventor: Robert Blanchard, Le Boupere (FR)

Correspondence Address: YOUNG & THOMPSON, 745 SOUTH 23RD STREET 2ND FLOOR, ARLINGTON, VA, 22202

(21) Appl. No.: 09/730,860

(22) Filed: Dec. 7, 2000

(30) Foreign Application Priority Data
Dec. 7, 1999 (FR) 99 15395

(51) Int. Cl. B25G 3/28

(52) U.S. Cl. 403/357

(57) ABSTRACT

The invention relates to an assembly of the type constituted by a cylindrical axle (1) of revolution and a hollow member (2) mounted securely in rotation on said axle (1).

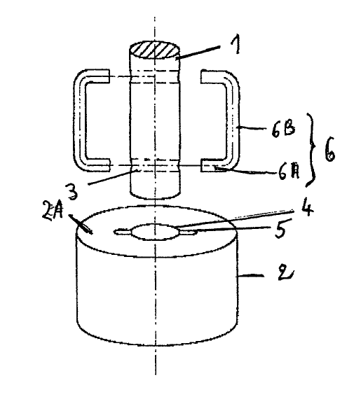

This assembly is characterized in that the axle (1) formed from a single piece comprises at least two radial holes (3) provided along one of its generatrixes, the hollow member (2) comprises at least one longitudinal groove (5) provided in a hole (4) along the member serving for the reception of the axle (1) and in that the assembly moreover comprises a staple (6) whose legs (6A) are arranged to be able to be introduced within said holes (3) of the axle (1) and whose body (6B) is of a shape complementary to the groove (5) of the member (2).

Use: clutches.

The present invention relates to an assembly of the type constituted by at least one axle and a hollow member, such as a wheel, a sleeve, a ring, a casing or the like, mounted secured in rotation on the axle, said hollow member being provided with a hole for receiving said axle.

There exist numerous means to secure fixedly in rotation a hollow member on an axle whilst leaving for this latter the possibility of axial displacement on the axle. The most frequent means used are keyways and the provision of suitable geometric shapes. Thus, the axle and the hollow member can comprise channel portions adapted to coact with each other during the introduction of the hollow piece onto the axle. Similarly, the axle and the hollow member can have complementary polygonal shapes. Such solutions have various drawbacks. In particular, they do not permit the use of a standard axle such as a cylindrical axle of revolution. Conversely, these solutions often require particular machining of the axle or of the hole of the hollow member, machining whose cost is generally high. Finally, recourse to a key arrangement gives rise to a relatively high assembly time.

An object of the present invention is to provide an axle/hollow member assembly whose design permits easy assembly of the hollow member and of the axle whilst permitting the use of standard pieces and/or pieces modified at a reduced cost.

Another object of the present invention is to provide an axle/hollow member assembly whose connection device is of small size, this connection device being adapted to be entirely hidden in the assembled condition of the hollow member on the axle.

Another object of the present invention is to provide an axle/hollow member assembly whose design permits, because of large mutual contact surfaces, manufacture from plastic members.

To this end, the invention has for its object an assembly of the type constituted by at least one cylindrical axle of rotation and a hollow member, such as a wheel, a sleeve, a ring, a casing or the like, mounted securely in rotation on the axle, said hollow member being provided with a hole for receiving said axle, characterized in that the axle formed from a single piece comprises at least two radial holes, blind or through, provided along a generatrix of the axle, the hollow member is provided with at least one longitudinal groove provided in the hole of the hollow member and opening at least in the front face for introduction of the hollow member onto the axle and in that the assembly moreover comprises at least one staple whose parallel legs have an axial distance substantially equal to that of the holes of the axle and a diameter less than that of the holes of the axle to be able to be introduced within said holes and whose body is of a shape complementary to the axial groove to permit, on the one hand during introduction of the hollow member on the axle, a sliding reception of the body of the staple in said groove, and on the other hand a driving in rotation without play of the hollow member during rotated driving of the axle.

The simplicity of the operations to be carried out to ensure the connection between the axle and the hollow member permits limiting the mounting time and obtaining a reduced assembly cost.

Thanks to this design of the assembly, the axle can be a standard smooth cylindrical axle.

The invention will be better understood from a reading of the following description of embodiments, with reference to the single FIGURE, which shows an exploded perspective view of the different constituent elements of the assembly.

The assembly according to the invention is constituted essentially by an axle 1, a hollow member 2 and at least one staple 6. The hollow member 2 can be constituted by a wheel, a sleeve, a ring, a casing, a pulley or any other piece comprising a hole 4 or a through or a blind cavity permitting the introduction of the piece 2 on the axle 1. This piece 2 is mounted securely in rotation on the axle 1 and if desired free in translation on said axle. The axle 1 itself is generally a rotatable motor shaft.

To permit the connection between said members, the axle 1 is provided with at least two radial holes 3, blind or through, provided along a generatrix of the axle 1. In the illustrated example, the radial holes 3 are through holes. The hollow member 2 comprises itself at least one longitudinal groove 5 provided along a generatrix of its hole 4. This longitudinal groove 5 opens at least through the frontal surface 2A for introduction of the hollow member 2 onto the axle 1. This groove 5 can also open onto the surface of the hollow member 2 opposite the frontal introduction surface 2A, in particular in the case in which there is desired an entirely free movement in translation of the hollow member 2 on the axle 1. The assembly also comprises a staple 6. This staple 6 is of substantially U shape, the crosspiece of the U constituting the body 6B of the staple whilst the legs of the U constitute legs 6A of said staple. The parallel legs 6A of the staple are of a diameter less than that of the holes 3 of the axle 1. These legs are spaced from each other by a distance corresponding substantially to the spacing distance of the holes 3 of the axle 1 to be able to be introduced within said holes 3. The body 6B of the staple is of a shape complementary to the axial groove 5 of the hole 4 of the hollow member 2 to permit, on the one hand, during introduction of the hollow member 2 onto the axle 1, a sliding reception of the body 6B of the staple 6 in said groove 5, and on the other hand a securement in rotation without play of the hollow member 2 and the axle 1 in a manner to reduce or even to eliminate any risk of wear of the assembly.

When an axial displacement of the hollow member 2 on the axle 1 is not desired, there can be used a complementary element to immobilize the hollow member 2 against translation along said axle 1. The mounting of such an assembly is extremely simple. After providing the holes 3 in the axle 1, the legs 6A of the staple are introduced without a tool into the holes 3 and then the hollow member 2, in the hole 4 of which has first been provided at least one axial groove 5, is introduced slidably on the staple. This mounting the assembly takes place by the same operations carried out in the reverse order.

The number of holes 3, of grooves 5 and staples 6 to be used or to be provided within the scope of such an assembly is a function of the choice of the operator. Thus, in a preferred solution according to that shown, the hollow member 2 comprises at least two grooves 5 provided diametrically opposed in the hole 4 of the hollow member 2. Each groove 5 serves for the slidable reception of the body 6A of a stable 6. The axle 1 also comprises, in this case, only two radial holes 3, said holes being through holes to permit the reception of two staples 6 as shown in the single FIGURE.

Such an assembly can be used in a large number of applications. By way of example, this assembly could form a part of a speed reducing mechanism, the hollow member 2 mounted on the axle 1 constituting one of the speed reducing mechanism members. Thus, in this case, the hollow member 2 is a toothed wheel mounted securely in rotation on the axle of the wheels of a wheeled machine, this toothed wheel coming into engagement also with an endless screw.

1. Assembly of the type constituted by at least one cylindrical axle (1) of revolution and a hollow member (2), such as a wheel, a sleeve, a ring, a casing or the like, mounted securely in rotation on the axle (1), said hollow member (2) being provided with a hole (4) to receive said axle (1),
characterized in that the axle (1) formed of a single piece comprises at least two radial holes (3), blind or through, provided along a generatrix of the axle (1), the hollow member (2) is provided with at least one longitudinal groove (5) provided in the hole (4) of the hollow member (2) and opening at least through the frontal surface (2A) for introduction of the hollow member (2) on the axle (1), and in that the assembly moreover comprises at least one staple (6) whose parallel legs (6A) have an axial distance substantially equal to that of the holes (3) of the axle (1) and a diameter less than that of the holes (3) of the axle (1) to be able to be introduced within said holes (3) and whose body (6B) is of a shape complementary to the axial groove (5) to permit, on the one hand during introduction of the hollow member (2) onto the axle (1), a sliding reception of the body (6B) of the staple (6) in said groove (5), and on the other hand a driving in rotation without play of the hollow member (2) during rotational drive of said axle (1).

2. Assembly according to claim 1,
characterized in that the hollow member (2) comprises at least two grooves (5) provided diametrically opposite in the hole (4) of the hollow member (2), each groove (5) serving for the sliding reception of the body (6A) of a staple (6).

3. Assembly according to one of claims 1 and 2,
characterized in that the hollow member is a toothed wheel of a speed reducing mechanism.

4. Assembly according to one of claims 1 to 3,
characterized in that the holes (3) of the axle (1) are through holes.
